(19) United States
(12) Patent Application Publication
(10) Pub. No.: US 2007/0140783 A1
(43) Pub. Date: Jun. 21, 2007

(54) Ball joint assembly with secondary liner

(76) Inventors: Timothy S O' Bryan, Sterling Heights, MI (US); Ian Kulasooriya, Troy, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/300,884

(22) Filed: Dec. 15, 2005

(51) Int. Cl. F16C 11/00

(52) U.S. Cl. 403/122

(57) ABSTRACT

A ball joint has a metallic ball stud shaft with a ball at one end that fits within a housing that defines a ball socket. A primary liner made of a non-metallic material surrounds the housing inside surface. The ball is separately encased in a secondary liner that acts as a seal to prevent moisture and debris from collectively corroding and marring the outside surface of the metallic ball and the primary liner. The primary and secondary liners rotate against each other and create a corrosion-free articulation surface. A dust seal part seals with the ball joint housing and the ball stud shaft. A recess in the ball accepts a tab formed on the secondary liner to prevent the secondary liner from rotating on the ball during ball articulation. Lubrication channels may be formed in the primary liner to lubricate the articulation surfaces of the liners.

### FIELD OF THE INVENTION

The present invention relates to a ball joint assembly, and more particularly, to an articulation liner for a ball joint assembly.

### BACKGROUND OF THE INVENTION

Modern vehicular steering systems typically manage the articulation of a variety of rods and linkages, such as tie-rods, using lube-for-life ball joints that respond to driver inputs. Likewise, vehicular suspension systems may employ lube-for-life ball joints at the end of control arms to facilitate suspension articulation. Although generally satisfactory for their given application, such lube-for-life ball joints have not been without their share of limitations. For instance, existing ball joint balls are susceptible to moisture and corrosion if their moisture seals become damaged, thereby increasing ball contact friction within the ball's liner. Any corrosion of the micro finish surface of the ball due to contaminants degrades the liner surrounding the ball during ball stud articulation, leading to liner degradation and a gap between the ball and the liner. Subjected to repeat accelerations during normal use, the ball joint may prematurely wear out and prompt a costly replacement. Additionally, current ball joint balls must be manufactured with a costly micro surface finish to facilitate low-friction rotation against their socket liners. Accordingly, a need exists for a ball joint that eliminates corrosion resistance, reduces ball contact friction during ball and socket articulation, and reduces ball surface finish requirements.

### SUMMARY OF THE INVENTION

A ball joint assembly has a ball stud shaft with a ball at one end. The ball is covered by a first liner, which is covered by a second liner. The first liner is held in place relative to the ball by a tab on the first liner that secures into a recession of the ball. The ball and first liner move relative to the second liner. The second liner may have lubricating channels to ensure lubrication access to the interfacing surfaces of the first liner and the second liner. To further reduce friction, the liner materials may be made of plastic or other corrosion resistant material.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a ball joint assembly depicting a primary and secondary liner according to the present invention;

FIG. 2 is a side view of a ball joint assembly depicting a primary and secondary liner according to the present invention;

FIG. 3 is a cross-sectional view of a ball joint assembly depicting a primary and secondary liner and an anti-rotation tab according to the present invention;

FIG. 4 is an enlarged cross-sectional view of a rotated ball within a socket depicting a primary and secondary liner and an anti-rotation tab according to the present invention;

FIG. 5 is a perspective view of a ball and socket assembly depicting a primary and secondary liner with an anti-rotation tab according to the present invention; and

FIG. 6 is a perspective view of a ball and socket assembly depicting a primary and secondary liner with an anti-rotation tongue and groove according to the present invention.

### DETAILED DESCRIPTION OF THE PREFERRED EMBODIMENTS

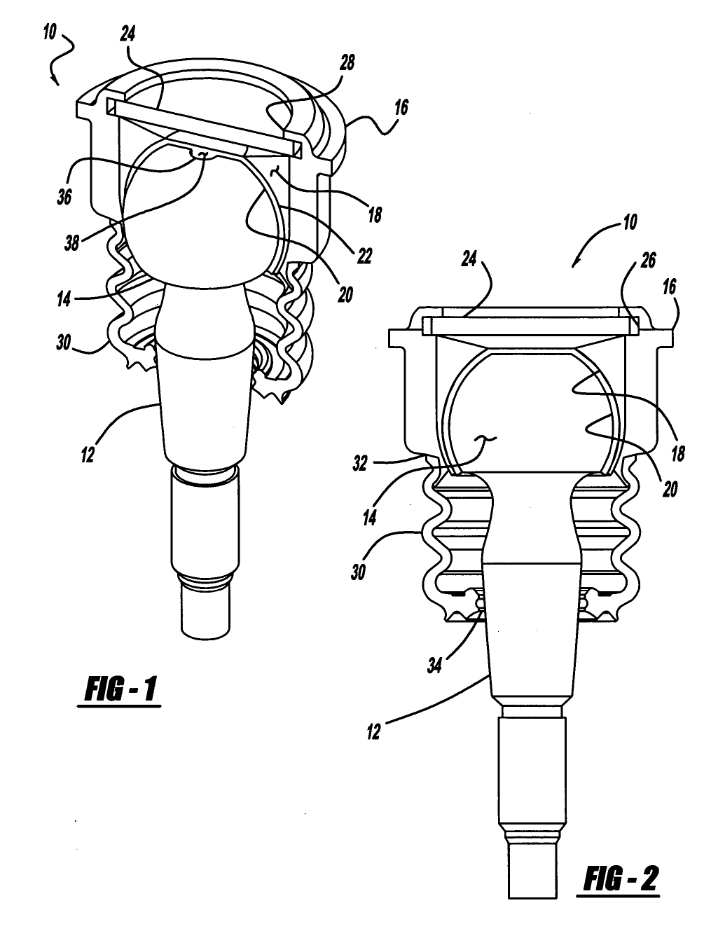

The following description of the preferred embodiments is merely exemplary in nature and is in no way intended to limit the invention, its application, or uses. With reference to FIGS. 1-6, the teachings of the present invention relate to a ball and socket joint. More specifically, the teachings relate to facilitating relative movement between liners in a dual liner system that is situated around a ball of a ball stud shaft. Turning now to the Figures, a detailed description of the ball joint structure will be presented.

FIG. 1 is a perspective view of a ball joint assembly 10 depicting a primary and secondary liner situated around a ball 14 of a ball stud shaft 12, according to the present invention. FIG. 2 is a side view of a ball joint assembly 10 depicting a primary liner 18 and a secondary liner 20 according to the present invention. More specifically, FIG. 1 depicts a ball joint assembly 10 having a ball stud shaft 12, ball 14, and a ball joint housing 16. The ball 14 of the ball stud shaft 12 fits into the ball joint housing 16. Disposed around the ball 14 in the ball joint housing 16 are a primary liner 18 and a secondary liner 20. More specifically, the primary liner 18 is inserted within the interior of the ball joint housing 16. The secondary liner 20 may be introduced as a separate part over the ball 14, or the secondary liner 20 may be formed over the ball 14 in an assembly molding process. The combination of the ball 14 and the secondary liner 20 is then inserted within the primary liner 18, which is resident within the housing 16. Alternatively, the ball 14 with the secondary liner 20 installed over it, may be installed into the primary liner 18, which may then be installed into the housing 16. Upon installation, the primary liner 18 forms a snug fit around the surface of the secondary liner 20, but the fit does permit corrosion-proof relative movement between the liners 18, 20, which is an advantage of the present invention. The secondary liner 20 lies over the ball 14, either as a molded part or installed as a separate part, and forms a snug, contact fit with the ball 14. The curved housing rim 39 secures the ball stud shaft 12 in place.

Continuing with reference to FIGS. 1 and 2, the ball joint housing 16 fits circumferentially around the ball 14 and liners 18, 20 and slightly curves with the contour of the ball 14 as the housing 16 approaches the ball stud shaft 12. Each end of the housing 16 is open. One end of the ball joint housing 16 is covered with a cover plate 24 while the opposite end is open to permit the ball stud shaft 12 to pass through. The cover plate 24 fits within a groove 26 of the ball joint housing 16 such that a lip 28 of the ball joint housing overlaps the cover plate 24. The groove 26 actually may be fashioned from a counterbore in the ball joint housing 16 with the lip 28 being crimped or rolled over, resulting in such groove 26.

Using the above construction, the cover plate 24 and ball joint housing 16 create a seal. FIGS. 1 and 2 depict a dust seal 30, which may be made of a flexible material such as rubber. One end of the dust seal 30 circumferentially adjoins to the ball joint housing 16 and creates a seal 32, while the opposite end of the dust seal 30 circumferentially adjoins to the ball stud shaft 12 and creates a seal 34. The dust seal 30 and the seals 32, 34 prevent moisture, dirt and other debris from reaching the ball 14, liners 18, 20 and their contacting surfaces. The cover plate 24 performs a similar task at the opposite end of the ball joint housing 16.

The operative workings of the ball joint assembly 10 will now be explained in conjunction with the balance of the ball joint structure with reference to FIGS. 1-6. The ball 14 may contain a hole or recession 36 which becomes the insertion point for a tab or projection 38 upon installation of the secondary liner 20. The secondary liner 20 may be press-fit around the ball 14 or molded around the ball 14, for example, in an over mold process. Alternatively, expansion reliefs could be molded or cut into the secondary liner 20 that would allow the secondary liner 20 to open during assembly to the ball 14. The reliefs would close when the secondary liner 20 and ball 14 assembly is assembled into the primary liner 18. Another process would be to intentionally oversize the secondary liner 20 and then after installing it on the ball 14, to thermally activate, or heat shrink the secondary liner 20 to the ball 14. Regardless of the manufacturing process, the tab 38 resides in the recession 36 to secure the secondary liner 20 to the ball 14.

The advantages of the dual liner ball joint assembly 10 will now be presented. Traditionally, ball joint balls have not had any protective covering snugly and independently attached to their exterior to protect their exteriors from corrosion. According to the teachings of the present invention, because the secondary liner 20 is firmly secured to the ball 14, moisture, dirt and debris are sealed from the surface of the ball 14 and the liners 18, 20. Because many ball joint balls are manufactured from metals susceptible to corrosion in the form of ball surface pitting, eliminating or reducing such corrosion is an advantage. Corrosion generally increases friction between surfaces if one or both contain corrosion. In the case where a metal ball is permitted to rotate within a plastic liner, friction caused by corrosion may increase the force necessary to operate the ball joint and make the ball joint less efficient. Additionally, upon being subject to repeated accelerations, a ball with corrosion may begin to suffer from gaps between the ball and the liner as the ball and liner wear.

Because the ball 14 of the present invention is sealed with the secondary liner 20 and the dust seal 30, corrosion of the ball surface 14 is eliminated. Additionally, because the secondary liner 20 is secured to the ball 14, in part by the tab 38 and ball recession 36, the secondary liner 20 does not move relative to the ball 14, when the ball 14 is rotated. The secondary liner 20 only moves relative to the primary liner 18. Since the primary liner 18 and secondary liner 20 of the present invention are made of a non-corrosive material, and are the only interfacing parts of the ball joint assembly 10 that interface and move relative to each, friction due to corrosion is eliminated.

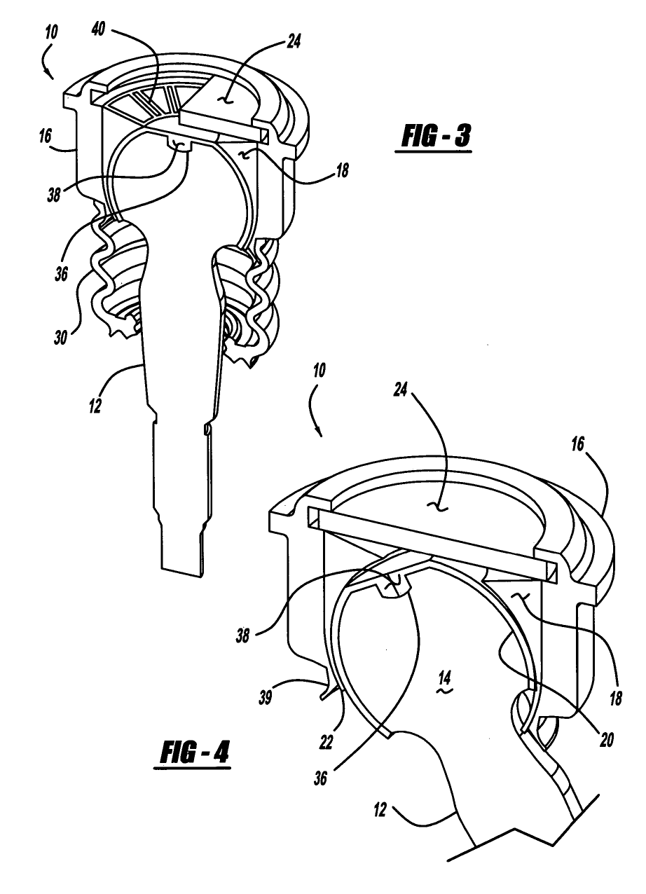

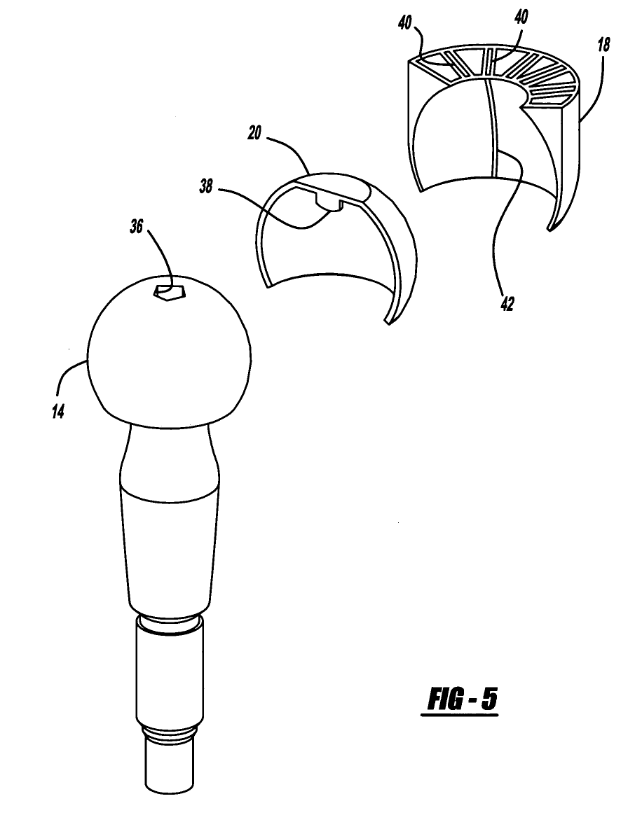

FIG. 4 is an enlarged cross-sectional view of a rotated ball 14 and ball stud shaft 12, relative to FIG. 3, within a ball joint housing 16 depicting a primary liner 18 and a secondary liner 20 and an anti-rotation tab 38 according to the present invention. Although the secondary liner 20, without the aid of any mechanical fastener, may be firmly secured to the ball 14 to eliminate relative motion between the ball 14 and the secondary liner 20, the liner tab 38 within the ball recession 36 provides an added mechanism to prevent relative movement between the secondary liner 20 and the ball 14. When the ball stud shaft 12 is rotated in any direction, for instance, from its FIG. 3 position to that of FIG. 4, the secondary liner 20 and primary liner 18 slide against and relative to each other. Because the liners 18, 20 are non-metallic and may be made of an acetal polyoxymethylene (POM) resin such as DuPont's Delrin® material or other suitable non-metallic material, friction due to corrosion is eliminated. Additionally, because the surfaces of liners 18, 20 are corrosion resistant, moisture on the articulation surfaces does not cause or promote corrosion of the liners 18, 20.

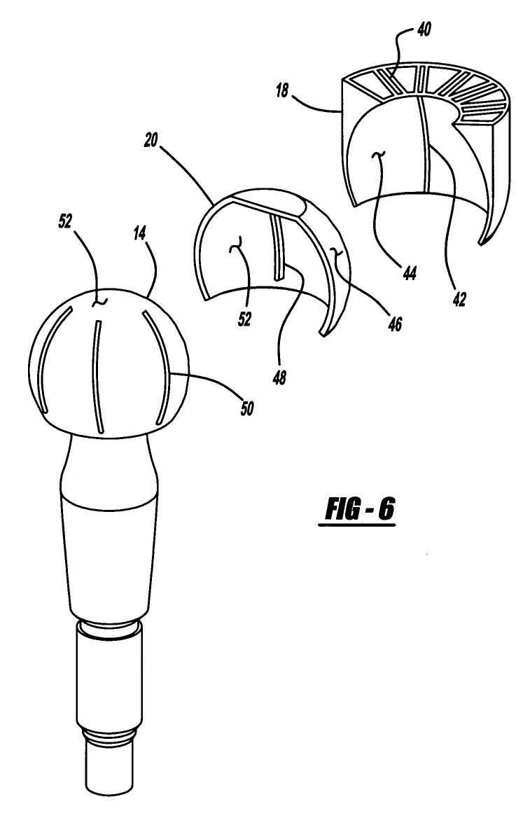

Turning to FIGS. 3-6, additional features of the present invention will be described. FIGS. 3 and 5-6 depict a lubrication channel 40 in a top portion the primary liner 18 of the ball joint assembly 10. FIGS. 5-6 depict an elongated lubrication channel 42 that is fluidly connected to the lubrication channel 40: The lubrication channels 40, 42 permit lubrication, in the form of a liquid or paste, for example, to penetrate the contact surfaces of the primary liner 18 and the secondary liner 20. More specifically, a lubricant is able to lubricate the primary liner inside wall surface 44 and the secondary liner outside wall surface 46, which interface with each other during articulation of the ball joint assembly 10. While FIGS. 5-6 depict only one elongated lubrication channel 42 in the primary liner inside wall surface 44, multiple channels may be used in order to achieve the desired level of lubricity.

Continuing with reference to FIG. 6, a protruding tongue 48 and groove 50 interlocking system are part of the present teachings. More specifically, the secondary liner 20 has a tongue 48 on its inside wall surface 52. The tongue 48 protrudes to securely and snugly fit within the groove 50 on the outside surface 52 of the ball 14. While FIG. 6 depicts only one tongue 48, any number of tongues could be used on the inside surface of the secondary liner 20 to maintain the secondary liner 20 against the ball 14 during ball stud shaft 12 articulation. Alternatively, the tongue 48 and groove 50 pairing could be reversed such that the ball outside surface 52 could be fitted with a tongue or tongues, while the secondary liner 20 could possess a groove or grooves. With the employment of the tongue and groove system, the secondary liner 20 is prevented from rotating on the ball outside surface 52. Additionally, with the secondary liner 20 securely fastened around the outside surface of the ball 14, the ball 14 is protected from moisture and contaminants that might otherwise cause corrosion on the surface of the metallic ball 14. While a tongue and groove method has been depicted and described, along with a tab and recess method, other fastening methods could be employed.

With the primary liner 18 and secondary liner 20 in place, and the secondary liner 20 firmly secured to the ball 14, a low friction ball joint is provided. That is, because the liners 18, 20 are made from a material such as Delrin®, they are permitted to slide against and relative to each other without contacting any potentially corroded metallic parts. This is possible because the ball 14 is isolated from the primary liner 18 with the secondary liner 20.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A ball joint apparatus comprising:
an outside liner;
an inside liner adjacent the outside liner;
a ball adjacent the inside liner; and
a ball stud shaft adjoined to the ball.

2. The ball joint apparatus of claim 1, further comprising a housing surrounding the outside liner and defining an open end.

3. The ball joint apparatus of claim 2, further comprising a dust seal, the dust seal creating a seal with the housing and the ball stud shaft.

4. The ball joint apparatus of claim 2, further comprising a cover plate situated over the open end of the housing.

5. The ball joint apparatus of claim 1, wherein the ball defines a recession, the apparatus further comprising:
a tab projecting from the inside liner and into the recession.

6. The ball joint apparatus of claim 1, further comprising:
a groove in the ball; and
a tongue projecting from the inside liner, the tongue interfacing with the groove.

7. The ball joint apparatus of claim 1, wherein the inside liner and the outside liner move relative to each other when the ball stud shaft moves.

8. The ball joint apparatus of claim 1, wherein the inside liner moves with the ball.

9. The ball joint apparatus of claim 1, wherein the outside liner defines at least one lubrication channel to permit fluid access to the interface of the outside liner and the inside liner.

10. A ball joint apparatus comprising:
a ball stud shaft having a ball at one end, the ball defining a recess;
a first liner surrounding the ball, the first liner having a protuberance that inserts into the recess;
a second liner that surrounds the first liner; and
a housing that peripherally surrounds the second liner.

11. The ball joint apparatus of claim 10, further comprising:
a dust seal, the dust seal creating a seal with the ball joint housing and the ball stud shaft.

12. The ball joint apparatus of claim 10, wherein the recess is a single hole in the ball.

13. The ball joint apparatus of claim 10, wherein the recess is a groove in the ball.

14. The ball joint apparatus of claim 10, further comprising a cover plate that covers an end of the ball joint housing.

15. The ball joint apparatus of claim 10, wherein the second liner defines at least one lubricating channel.

16. A dual liner arrangement for use with a ball joint comprising:
a ball stud shaft with a ball at one end, the ball defining a recession;
a first liner adapted to the ball, the first liner having a tongue adaptable to the recession; and
a second liner adapted to the first liner, the second liner permitting movement of the first liner against a surface of the second liner.

17. The ball joint apparatus of claim 16, further comprising a housing that peripherally surrounds the second liner.

18. The ball joint apparatus of claim 16, further comprising a through-channel in the second liner, the through-channel permitting liquid lubrication to pass through the second liner.

19. The ball joint apparatus of claim 16, further comprising a housing to prevent relative movement between the housing and the second liner.

20. The ball joint apparatus of claim 19, further comprising a dust seal, the dust seal fixed around the ball stud shaft and the housing.
